(19) United States
(12) Patent Application Publication
(10) Pub. No.: US 2026/0062100 A1
(43) Pub. Date: Mar. 5, 2026

(54) Surface Formation for Water Sports Board

(71) Applicant: Shengwei Liang, Vista, CA (US)

(72) Inventor: Shengwei Liang, Vista, CA (US)

(21) Appl. No.: 19/313,817

(22) Filed: Aug. 28, 2025

Related U.S. Application Data
(60) Provisional application No. 63/688,269, filed on Aug. 28, 2024.

(51) Int. Cl. B63B 32/59; B33Y 10/00; B33Y 30/00; B33Y 80/00; B41J 3/407; B63B 32/70

(52) U.S. Cl. CPC B63B 32/59; B33Y 10/00; B33Y 30/00; B63B 32/70; B33Y 80/00; B41J 3/4073

(57) ABSTRACT

An apparatus and method is provided for forming a friction enhanced non-slip surface upon a water sports board comprising a computer controlled print head which deposits UV curable liquid material in defined patterns or areas on a riding surface of a water sports board. UV curing light emitters cure the liquid material to form friction enhanced areas upon the sports board.

This application claims priority to U.S. Provisional Patent Application Ser. No. 63/688,269 filed on Aug. 28, 2024.

### BACKGROUND OF THE INVENTION

### 1. Field of the Invention

The invention herein disclosed relates generally to sports boards used for water sports. More particularly, it relates to a raised frictional riding surface for a water sports board, such as a paddle board or surfboard, which is imparted with a large format printer.

### 2. Prior Art

Water sports board riding, such as surfboards and stand up paddle boarding, have become widely enjoyed by millions of people worldwide for both exercise and leisure riding. Conventionally, there are considerations concerning the purchase or even renting of paddle boards, for example. For most riders, a major consideration is the shape of the board and whether the paddle board has the desired volume and capacity. Other considerations include the length, width, and thickness of the paddle board they intend to use.

Currently, sports boards, such as paddle boards, are available in the marketplace in either a solid and fixed configuration or an inflatable board which is better adapted for transport and shipping by the rider.

With regard to actual riding of the board, rendering the top or riding surface to be non-slip is of great concern since if you cannot easily stand on the board due to a slippery surface, riding it is less than pleasurable. To that end, the positioning of wax on the riding surface, much like a surfboard, or the use of peel and stick surface enhancers are widely employed solutions.

With respect to the above, before explaining at least one preferred embodiment of the riding surface for water sports boards herein, it is to be understood that the printing of customized riding surfaces of the system herein is not limited in its application to the details of employment and to the arrangement of the components or the steps set forth in the following description or illustrated in the drawings. The various components and configurations and steps in formation of customized riding surfaces for paddle boards and water sports boards, are capable of other embodiments, and of being practiced and carried out in various ways, all of which will be obvious to those skilled in the art once the information herein is reviewed.

Also, it is to be understood that the phraseology and terminology employed herein are for the purpose of description and should not be regarded as limiting. As such, those skilled in the art will appreciate that the conception upon which this disclosure is based, may readily be utilized as a basis for the formation and manufacture of riding surfaces for other water sports boards and the like. It is important, therefore, that the embodiments, objects and claims herein, be regarded as including such equivalent construction and methodology insofar as they do not depart from the spirit and scope of the present invention.

### SUMMARY OF THE INVENTION

The disclosed system and method thereof herein provide a highly customizable system for the placement of friction enhancing surfaces on the exterior of a water sports board, such as a paddle board.

The system is configured to position customized friction enhancing surface areas primarily upon the riding surface of the water sports board to provide riders with an area for placement of their body, or their feet, when riding atop the water sports board. The system operates to provide a highly customized placement of a curable liquid upon the riding surface of the water sports board. This customized placement, as well as the customized shapes, spacing, and depth of curable material employs software running in electronic memory on a computer to generate individual curable deposits upon the board surface which will form the desired friction enhanced areas to prevent slipping.

The system provider, in the system herein described, as noted above and further described below, may employ one or a plurality of computing devices, such as computers and servers which have network communications, such as the internet or private networks. The computing devices have accessible electronic memory or non-transitory computer readable medium in which software configured for the tasks, noted herein, will operate, which employs computer executable instructions stored thereon. Such instructions include the steps herein, such as depicting non slip surface patterns which may be formed on a sports board and allowing a user to customize such patterns, and then controlling movement of the sports board as well as that of a print head to deposit UV curable material upon the sports board to form the chosen customized friction enhancing areas.

A non-transitory computer readable medium having an executable computer program stored thereon, has executable code which will run in electronic memory which operates to perform all the steps and the tasks noted herein. Such electronic memory, in communication with the computing device or server or the like, may also hold in electronically accessible fashion, one or a plurality of different shapes and patterns for the friction enhancing surface, and/or routines allowing a user to choose and form customized shapes and areas of friction enhancing surface upon a sports board.

By allowing for the customized generation of one or a plurality of friction enhanced areas formed by UV curable liquid material, the system thus allows for formation of drain channels within the friction surface to enhance water drainage. It also allows for the positioning of differently configured friction enhanced areas on different locations of the water sports board, such as to accommodate the experience of a rider, whether the rider is right or left footed and for other customizable adaptations of the deposited UV curable liquid material, such as inks, coatings and adhesives, to form the desired type and position of customized surface. By UV curable liquid material herein, is meant any ink jet or print head sprayable liquid which is UV-curable. Such, for example only, may be a flexible polymer such as a liquid formulation containing oligomers and monomers that can be applied to a surface via spraying by a computer controlled print head, and then rapidly hardened by exposure to ultraviolet (UV) light. This transforms the sprayed liquid in patterns of dots and lines into a pliable or flexible, durable polymeric or similar layer adhered to a sports board riding surface. More or less pliability may be achieved, for example, by incorporating specific oligomers that provide a degree of inherent pliability, while photo initiators are added to initiate the polymerization process upon UV exposure. Other materials which are liquid and will spray from the nozzles of a print head may also be employed which will cure under UV light to thereby form the sprayed dots and lines into the desired patterns for a friction enhanced surface.

Using a wide-format printing device and having a computer controlled moving print head for the UV curable liquid, herein called an inkjet printer for convenience, using a computer controlled print head sliding on a mount, the system can spray any type of liquid UV curable material which is adapted to the formation of the desired friction enhanced surface area on a water sports board. The term inkjet printer is for convenience herein and means any computer controllable print head having one or a plurality of jets capable of depositing the chosen UV curable liquid material on the sports board surface in a highly accurate manner for each drop or portion of sprayed liquid.

Currently, the system is well adapted to printing such friction enhancing surfaces on inflatable water sports boards, as well as solid and rigid such water sports boards. Due to the more planar nature and lightweight characteristics of an inflatable water sports board, the system herein works especially well in forming enhanced and decorative friction enhanced areas thereon. However, it is also easily applicable to more solid and non-inflatable water sports boards.

Using UV emitting light sources positioned above a sports board on which customized printing has been sprayed, the image or shapes in individual areas and formed gaps and water drainage pathways can be quickly cured and fixed in place. Thus, the system allows not only for the manufacturer of such sports boards to form customized individual and large areas, they can also offer customers for such water sports boards the option to input their own decorative patterns and artwork for inclusion on the surface. Such can be included in combination with the customized shapes of the sprayed UV curable liquid or without.

With respect to the above description, before explaining at least one preferred embodiment of the enhanced friction riding surface system for positioning on a water sports board and the manufacturing thereof herein, it is to be understood that the invention is not limited in its application to the details of operation nor the arrangement of the components or the steps set forth in the following description or illustrations in the drawings. The various methods of implementation and operation of the riding surface for water sports boards herein are capable of other embodiments and of being practiced and carried out in various ways which will be obvious to those skilled in the art once they review this disclosure. Also, it is to be understood that the phraseology and terminology employed herein are for the purpose of description and should not be regarded as limiting.

Therefore, those skilled in the art will appreciate that the conception upon which this disclosure is based may readily be utilized as a basis for designing of other systems for positioning riding surfaces on water sports boards and for carrying out the several purposes of the disclosed system herein. Therefore, the objects and claims herein should be regarded as including such equivalent construction, steps, and methodology insofar as they do not depart from the spirit and scope of the present invention.

It is an object of this invention to provide a system for positioning customized raised surfaces for riding and other purposes upon water sports boards, such as paddle boards.

It is a further object of this invention to provide such a system for customized raised surfaces which can be customized for each rider as to their desired foot or body position and other customizable aspects.

It is an additional object of this invention to provide such a water sports board surfacing system which can position customized shapes to riding surfaces of water sports boards.

Another object is the use of non-impact direct printing technology which deposits UV curable liquid in a patterned array, such as the dot matrix, to form small blocks, ribs, and small sections in shapes configured to maximize traction for a rider.

These, together with other objects and advantages, which become subsequently apparent, reside in the details of the construction and operation of the surfacing system for water sports boards herein as more fully hereinafter described and claimed, reference being had to the accompanying drawings forming a part thereof, wherein like numerals refer to like parts throughout.

Further objectives of this invention will be ascertained by those skilled in the art as brought out in the following part of the specification wherein detailed description is for the purpose of fully disclosing the invention without placing limitations thereon.

### BRIEF DESCRIPTION OF DRAWING FIGURE

FIG. 1 shows the formation of the customized exterior surface of a water sports board, such as a paddle board, using a printing device which positions individual projections of light-curable liquid upon the surface of the water sports board sliding thereunder on a sliding support to form a riding surface thereon.

FIG. 2 shows an example of the formed surface for riding upon on a water sports board once the liquid is cured.

FIG. 3 depicts an overhead view of a water sports board, such as a paddle board or surfboard showing the customized riding surface formed using the printer and curable material in FIG. 1 and showing customized drainage channels formed thereby to enhance water removal from the surface.

FIG. 4 depicts a top surface of a water sports board, such as a paddle board or surfboard, wherein the riding surface is customized to enhance rideability by the user positioned thereon in differing positions.

FIG. 5 depicts an example of the curable liquid deposited in the system in FIG. 1 wherein individual raised projections are formed that rise above an engagement to the riding surface and may rise above surrounding friction enhanced surfaces of the water sports board.

FIG. 6 shows cured surface material positioned upon a water sports board wherein the shape of individual projections or points defining the formed surface are customized and channels are formed as recesses in the surface to aid in drainage of water therefrom.

FIG. 7 depicts some of the infinite number of different shapes in which the projections may be formed to form the overall riding surface on the water sports board to thereby customize all or multiple areas thereof with respective projections of different shape.

### DETAILED DESCRIPTION OF THE PREFERRED EMBODIMENTS OF THE INVENTION

In this description, the directional prepositions of up, upwardly, down, downwardly, front, back, top, upper, bottom, lower, left, right, and other such terms refer to the device as it is oriented and appears in the drawings and are used for convenience only. Any such terms are not intended to be limiting or to imply that the device has to be used or positioned in any particular orientation.

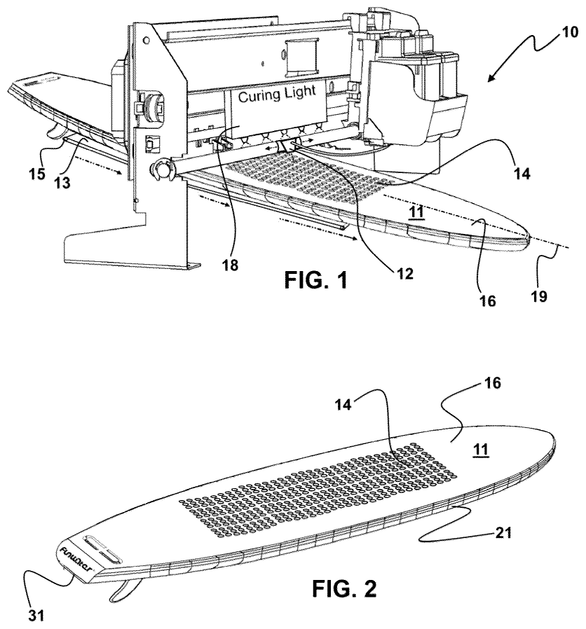

Referring now to the water sports board riding surface formation system 10 in the depictions of FIGS. 1-7, there is seen in FIGS. 1-2 a graphic depiction of the system 10 herein using a large format printing type apparatus with a translating liquid-positioning print head 12. The movement of the print head 12 is computer controlled for both movement and duration of ejection of drops or portions of liquid from a nozzle of a print head 12, to form the friction enhancing surface area 14 upon the water sports board 16.

The sports board, such as a paddle board, or surfboard, or other board, for a rider is shown following a sliding path which moves the sports board 16 under the print head 12 on a sliding support surface with the upper or riding surface 11 of the sports board 16 facing the print head 12. Such a sliding support surface is also computer controlled for the rate of movement. Such a sliding support surface may be, for example, and in no way limiting, a conveyer belt 13 driven by an electric motor 15 or a sliding table driven by an electric motor, or a similar system, for controlled translational movement of a sliding support surface.

The movement of the print head 12 and translation of the sports board 16 on the sliding support surface are both controlled by software operating to the tasks of translating the print head 12 on a print head support 17, while concurrently controlling the duration of projection an angle of projection of the surfacing liquid from nozzles on the print head 12.

The software also operates to the task of concurrently controlling the translation of the riding surface 11 of the sports board 16 under the print head 12 on the sliding support surface, such as on a conveyer belt 13 or sliding table which is motor 15 driven, to form the desired pattern or image or the like.

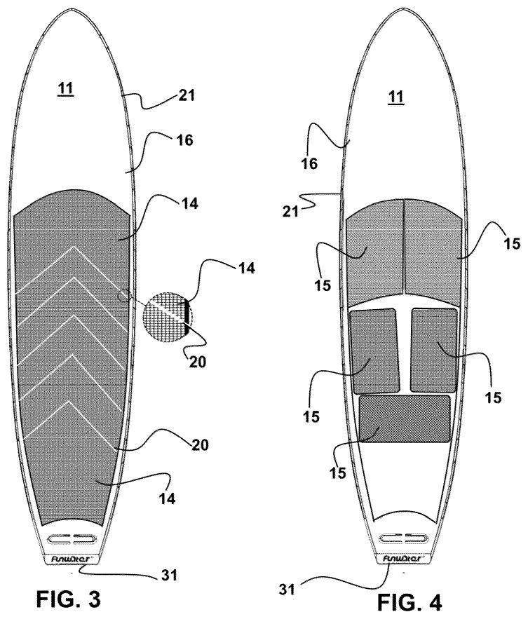

Upon the positioning of the liquid material from the computer software controlled nozzles of the print head 12 upon the riding surface 11 side of the sports board 16, the dots or projecting portions of UV curable liquid as noted above, in the desired individual positions on the sports board 16 is cured using a UV light emitter 18. This UV curing fixes the individual dots or lines of liquid material in place upon the riding surface 11 to form the design or patterns to provide the friction enhanced surface 14. For example only, and in no way limiting, FIG. 3 shows a depiction of a friction enhanced surface 14 formed upon the riding surface 11 of a sports board 16. Shown in an overhead view of the water sports board 16, such as a paddle board or surfboard showing the customized riding surface formed using the print head 12 and curable material in FIG. 1.

′As shown, the friction enhanced surface 14 includes drain channels 20 formed as recessed areas within the friction enhanced surface 14. Such drain channels 20 are formed by limiting the deposit of the liquid which is UV cured to form the friction enhanced surface 14 to form diagonal channels at a depth below the top of the friction enhanced surface and an angle and length to maximize the drainage of water from the top of the surrounding friction enhanced surface 14.

The drain channels 20 can be customized for each sports board 16 and rider thereof and customization is provided by software operating to the task of changing the depth and angle of the drain channels 20. By angle is meant an angle of the drain channels from an imaginary center axis 19 running down the center of the sports board 16 toward side edges 21 of the water sports board 16. Currently, a rearward angle is shown in FIG. 3 where the drain channels 20 have a first end starting in a central area of the sports board 17 and which angle toward the rear end 31 of the sports board 16 to position a second end of the drain channels 20 adjacent a side edge 21 thereof. Such has been found in experimentation to work especially well by using the forward movement of the sports board 16 on the water to force water into the formed drain channels 20 and out thereof at the side edges 21.

In FIG. 4 is shown an example of the system 10 herein, forming customized surface areas 15 where each may be formed of a differing friction enhancing material. The customized surface areas 15 may also be positioned on the sports board 16 in a fashion to maximize the non-slip areas to either or both of the rider's ability and/or the rider's physical characteristics. By physical characteristics is meant their height and weight and foot size and other physical aspects for which customized surface areas 15 of the friction enhanced surface 14 may be placed to enhance the ability of the rider to use the water sports board 16.

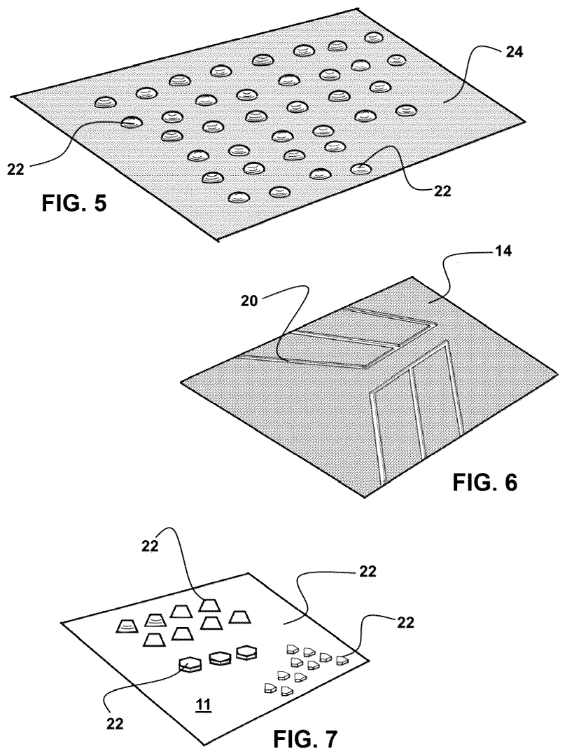

It should be noted, each of the customized surface areas 15 may be formed using the computer controlled nozzles of the print head 12 to lay down surfaces with height and gaps and shaped areas, such as shown in FIGS. 5-7 in the designated customized surface area 15, to work best to enhance rideability of the sports board 16 for the known rider.

Shown in FIG. 5 is one example of the UV curable liquid deposited by the print head 12 shown in the system in FIG. 1. As shown, individual raised projections 22 which may be circular or other shapes and are formed to have a top surface which rises a height above their respective engagement to the riding surface 11 of the water sports board 16. The raised projections 22 may be positioned within or atop a combination friction enhanced surface 24 including the raised projections 22. For example only, and in no way limiting, the raised projections 22 can be adjusted for height above the riding surface, spacing between each raised projection, differing diameter of each raised projection, and a durometer of the cured material of each raised projection 22.

In FIG. 6 is depicted another example which as noted and should in no way be considered limiting, shows cured friction enhanced surface 14 positioned upon a water sports board 16 which is formed by very small individual raised projections 22, such as in FIG. 5 and FIG. 7, where the respective perimeter and top surface shape of each individual projection 22, defining the formed friction enhanced surface 14, can be customized. The customization can be for both enhanced slip-resistance, as well as for water drainage to further enhance slip resistance by changing shape, height, diameter, and durometer and the like. The water drainage may be enhanced using the formed drain channels 20 and similar recessed area adapted to encourage water to drain from the area of the friction enhanced surface 14.

Shown in FIG. 7 are enlarged examples of the formation of each projection 22 located on top of the friction enhanced surface 14 positioned on the riding surface 11. While a number of shapes, heights, and spacing of the individual projections 22 are shown as exemplars only, for forming a customized friction enhanced surface 14 on the water sports board, these elements of each raised projection 22 formed by the cured liquid from the print head 12 are infinitely adjustable and as one skilled in the art will discern, other shapes, heights, spacing, diameter, durometer may be employed to achieve the desired friction enhanced surface 14 adapted to the skill, age, and physical characteristics of each rider. Currently, the shape of the perimeter of the raised projections 22 may be one or a combination of shapes from a group of raised projection shapes including circles, triangles, rectangles, pentagons, and hexagons. Each of these different shapes provides different friction enhancing characteristics and a user may wish to experiment with samples and then choose a shape or shapes to employ.

In the method of forming a riding surface upon a sports board 16 herein, a computer running software operating to perform the above noted functions and tasks will control the sliding surface 13 to slide the riding surface 11 under the print head 12 which sprays the UV curable liquid upon the riding surface 11. The print head 12 computer controlled to slide on a mount 17, and computer controlled as to the amount and duration of spraying of UV curable liquid upon the riding surface 11 to form portions of the UV curable liquid to dots and lines and other shapes such that a friction enhanced surface 14 is formed when the UV curable liquid is cured by a UV light emitter 18. The software operates to control al movement of the sports board 16 and print head 12 and the ejection of UV curable liquid therefrom, to form customized friction enhanced surfaces 14 upon the riding surface 11 which may be in customized shapes of raised projections 22 to form patterns or small areas or water channels 20 therein, as well as the other noted features above.

While all of the fundamental characteristics and features of the surface formation system for a water sports board have been shown and described herein, with reference to particular embodiments thereof, a latitude of modification, various changes, and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. A system for forming friction enhanced surfaces upon a sports board, comprising:
a print head, said print head operatively positioned on a mount;
a sliding support for supporting a lower surface of a water sports board thereon;
one or more computer processors having memory communicably coupled thereto;
a computer program product tangibly embodied in a non-transitory machine-readable storage medium, including instructions that, when executed by said one or more computer processors, cause the one or more processors to perform the steps of:
controlling said sliding support to move a sports board positioned thereon, underneath said print head;
controlling said print head to emit UV curable liquid therefrom upon said riding surface of said sports board; and
controlling a UV light emitter to cure said curable liquid positioned on said riding surface into areas of friction enhanced surface upon said riding surface.

2. The system for forming friction enhanced surfaces upon a sports board of claim 1, additionally comprising:
forming one or a plurality of drain channels into said areas of friction enhanced surface.

3. The system for forming friction enhanced surfaces upon a sports board of claim 2, additionally comprising:
forming said one or plurality of drain channels into said areas of friction enhanced surface at rearward angles having a first end of each said drain channel in a central area of the sports board and angling toward the rear end of the sports board to a second end of said drain channels adjacent a side edge of said sports board.

4. The system for forming friction enhanced surfaces upon a sports board of claim 1, additionally comprising:
controlling said print head to emit said UV curable liquid therefrom to form raised projections which project above a surrounding area of said friction enhanced surface.

5. The system for forming friction enhanced surfaces upon a sports board of claim 2, additionally comprising:
controlling said print head to emit said UV curable liquid therefrom to form raised projections which project above a surrounding area of said friction enhanced surface.

6. The system for forming friction enhanced surfaces upon a sports board of claim 3, additionally comprising:
controlling said print head to emit said UV curable liquid therefrom to form raised projections which project above a surrounding area of said friction enhanced surface.

7. The system for forming friction enhanced surfaces upon a sports board of claim 4, additionally comprising:
forming said raised projections in one or a combination of shapes from a group of raised projection shapes including circles, triangles, rectangles, pentagons, and hexagons.

8. The system for forming friction enhanced surfaces upon a sports board of claim 5, additionally comprising:
forming said raised projections in one or a combination of shapes from a group of raised projection shapes including circles, triangles, rectangles, pentagons, and hexagons.

9. The system for forming friction enhanced surfaces upon a sports board of claim 5, additionally comprising:
forming said raised projections in one or a combination of shapes from a group of raised projection shapes including circles, triangles, rectangles, pentagons, and hexagons.

10. An apparatus for forming a friction enhanced non-slip surface upon a water sports board comprising:
a print head, said print head operatively positioned on a mount;
a sliding support for supporting a lower surface of a water sports board thereon;
said sliding support for sliding said water sports board along a pathway below said print head;
said print head for depositing UV curable liquid upon a riding surface of said water sports board traveling along said pathway; and
a UV light emitter, said UV light emitter for curing said curable liquid material to form friction enhanced areas upon said riding surface.
